(19) United States
(12) Patent Application Publication
(10) Pub. No.: US 2026/0261350 A1
(43) Pub. Date: Sep. 3, 2026

(54) CONTROL DEVICE, CONTROL METHOD, AND RECORDING MEDIUM

(71) Applicant: NEC Corporation, Tokyo (JP)

(72) Inventors: Minoru KOBAYASHI, Tokyo (JP); Hiroki TANAKA, Tokyo (JP); Shigeharu TSUKAGOSHI, Tokyo (JP); Hitoshi ARAYA, Tokyo (JP)

(73) Assignee: NEC Corporation, Tokyo (JP)

(21) Appl. No.: 19/158,100

(22) PCT Filed: Dec. 28, 2023
(86) PCT No.: PCT/JP2023/047147

§ 371 Date: Aug. 20, 2025

(30) Foreign Application Priority Data
Feb. 28, 2023 (JP) 2023-029647

(51) Int. Cl. H04B 17/345

(52) U.S. Cl. CPC H04B 17/345

(57) ABSTRACT

Please delete the Abstract of the Disclosure, and replace it with the following:

To reduce an influence of interference in communication using underwater sound waves, a control device estimates whether each wireless communication device is influenced by an interference wave based on an influence range, when the interference wave occurs, which is a range where interference is likely to occur in wireless communication due to an influence of the interference wave. Based on the influence range, the control device identifies non-interference wireless communication devices from among devices using sound waves with frequencies capable of reducing the influence of the interference wave on an interference wireless communication device, the non-interference wireless communication devices being present at positions not influenced by the interference wave. The control device determines a non-interference wireless communication device to exchange use frequencies with the interference wireless communication device and instructs both devices to change their use frequencies .

### METHOD, AND RECORDING MEDIUM

### Technical Field

The present invention relates to a control device and the like.

### Background Art

It is considered to perform communication using sound waves underwater. Hereinafter, underwater communication using sound waves may be referred to as underwater sound wave communication.

Since an attenuation amount of radio waves is large underwater, communication by radio waves cannot be used in deep water. Therefore, in deep water, sound waves are more suitable for communication than radio waves.

As related techniques, there are techniques described in PTL 1 to 4.

### CITATION LIST

### Patent Literature

PTL 1: JP 2019-217835 A
PTL 2: JP 2019-096111 A
PTL 3: JP 2017-076877 A
PTL 4: JP 2009-260756 A

### Non Patent Literature

NPL 1: Takenobu Tsuchiya, “Numerical Simulation of Sound Propagation in Ocean”, SIG Technical Report of Information Processing Society of Japan, June 2019

### SUMMARY OF INVENTION

### Technical Problem

In recent years, a method has been known in which a control device on land or on water communicates with an underwater communication device via a base station floating on a water surface. At this time, communication between the base station and the communication device is performed by underwater sound wave communication. Communication between the base station and the control device is performed by radio wave communication or wired communication.

In such a case, when a plurality of communication devices are present underwater, each communication device communicates with the base station, and thus interference may occur between sound waves transmitted from the plurality of communication devices or the base station. Therefore, a company that performs underwater sound wave communication determines in advance a frequency of the sound wave to be used by each communication device so that as little interference as possible occurs.

However, even if frequencies to be used is determined so as to cause as little interference as possible, interference may occur between sound waves transmitted from a communication device or a base station and an interference source to disable communication in such a case that: another company conducts a business using underwater sound wave communication in an adjacent region to the business region; or an unexpected interference source occurs, for example, when construction to emit sound is performed on water, on land, or underwater.

In view of the above-described problems, an object of the present invention is to provide a control device and the like capable of reducing an influence of interference in communication using underwater sound waves.

### Solution to Problem

According to an aspect of the present invention, a control device is a control device that is connected to a base station and controls a use frequency, the base station performing wireless communication using sound waves with a plurality of wireless communication devices present underwater, the use frequency being a frequency to be used for the wireless communication by each of the wireless communication devices. The control device includes: influence estimation means for estimating whether each of the wireless communication devices is influenced by an interference wave, based on an influence range, when the interference wave occurs, the interference wave being likely to interfere with the wireless communication, the influence range being a range in which interference is likely to occur in the wireless communication due to an influence of the interference wave; determination means for identifying, based on the influence range, non-interference wireless communication devices from among the wireless communication devices each using, for the wireless communication, a sound wave having a frequency capable of reducing an influence of the interference wave on an interference wireless communication device, and for determining a non-interference wireless communication device to exchange use frequencies with the interference wireless communication device, from among the identified non-interference wireless communication devices, the interference wireless communication device being the wireless communication device influenced by the interference wave, the non-interference wireless communication devices being the wireless communication devices each present at a position not influenced by the interference wave; and instruction means for instructing the interference wireless communication device and the non-interference wireless communication device that exchange use frequencies with each other, each to change a use frequency to a frequency after exchange.

According to another aspect of the present invention, a control system is a control system that is connected to a base station and controls a use frequency, the base station performing wireless communication using sound waves with a plurality of wireless communication devices present underwater, the use frequency being a frequency to be used for the wireless communication by each of the wireless communication devices. The control system includes: influence estimation means for estimating whether each of the wireless communication devices is influenced by an interference wave, based on an influence range, when the interference wave occurs, the interference wave being likely to interfere with the wireless communication, the influence range being a range in which interference is likely to occur in the wireless communication due to an influence of the interference wave; determination means for identifying, based on the influence range, non-interference wireless communication devices from among the wireless communication devices each using, for the wireless communication, a sound wave having a frequency capable of reducing an influence of the interference wave on an interference wireless communication device, and for determining a non-interference wireless communication device to exchange use frequencies with the interference wireless communication device, from among the identified non-interference wireless communication devices, the interference wireless communication device being the wireless communication device influenced by the interference wave, the non-interference wireless communication devices being the wireless communication devices each present at a position not influenced by the interference wave; and instruction means for instructing the interference wireless communication device and the non-interference wireless communication device that exchange use frequencies with each other, each to change a use frequency to a frequency after exchange.

According to still another aspect of the present invention, a control method is a control method of a control device that is connected to a base station and controls a use frequency, the base station performing wireless communication using sound waves with a plurality of wireless communication devices present underwater, the use frequency being a frequency to be used for the wireless communication by each of the wireless communication devices. The control method includes: estimating whether each of the wireless communication devices is influenced by an interference wave, based on an influence range, when the interference wave occurs, the interference wave being likely to interfere with the wireless communication, the influence range being a range in which interference is likely to occur in the wireless communication due to an influence of the interference wave; identifying, based on the influence range, non-interference wireless communication devices from among the wireless communication devices each using, for the wireless communication, a sound wave having a frequency capable of reducing an influence of the interference wave on an interference wireless communication device, and determining a non-interference wireless communication device to exchange use frequencies with the interference wireless communication device, from among the identified non-interference wireless communication devices, the interference wireless communication device being the wireless communication device influenced by the interference wave, the non-interference wireless communication devices being the wireless communication devices each present at a position not influenced by the interference wave; and instructing the interference wireless communication device and the non-interference wireless communication device that exchange use frequencies with each other, each to change a use frequency to a frequency after exchange.

According to still another aspect of the present invention, a control program recorded on a computer-readable recording medium is a control program of a control device that is connected to a base station and controls a use frequency, the base station performing wireless communication using sound waves with a plurality of wireless communication devices present underwater, the use frequency being a frequency to be used for the wireless communication by each of the wireless communication devices. The control program includes causing a computer to implement: an influence estimation function for estimating whether each of the wireless communication devices is influenced by an interference wave, based on an influence range, when the interference wave occurs, the interference wave being likely to interfere with the wireless communication, the influence range being a range in which interference is likely to occur in the wireless communication due to an influence of the interference wave; a determination function for identifying, based on the influence range, non-interference wireless communication devices from among the wireless communication devices each using, for the wireless communication, a sound wave having a frequency capable of reducing an influence of the interference wave on an interference wireless communication device, and for determining a non-interference wireless communication device to exchange use frequencies with the interference wireless communication device, from among the identified non-interference wireless communication devices, the interference wireless communication device being the wireless communication device influenced by the interference wave, the non-interference wireless communication devices being the wireless communication devices each present at a position not influenced by the interference wave; and an instruction function for instructing the interference wireless communication device and the non-interference wireless communication device that exchange use frequencies with each other, each to change a use frequency to a frequency after exchange.

### Advantageous Effects of Invention

According to the above aspect of the present invention, it is possible to reduce the influence of interference in communication using underwater sound waves.

### BRIEF DESCRIPTION OF DRAWINGS

FIG. 1 is a diagram illustrating a configuration example of a control device according to a first example embodiment of the present invention.

FIG. 2 is a diagram illustrating an example of an operation flow of the control device according to the first example embodiment of the present invention.

FIG. 3 is a diagram illustrating a configuration example of a communication system including a control device according to a second example embodiment of the present invention.

FIG. 4 is a diagram illustrating a configuration example of the control device according to the second example embodiment of the present invention.

FIG. 5 is a diagram illustrating an example of an operation flow of the control device, a base station, and a wireless communication device according to the second example embodiment of the present invention.

FIG. 6 is a diagram illustrating a hardware configuration example of each example embodiment of the present invention.

### EXAMPLE EMBODIMENTS

### First Example Embodiment

A first example embodiment of the present invention is described. A specific example of a control device 10 in the first example embodiment is a control device 20 in a second example embodiment described below.

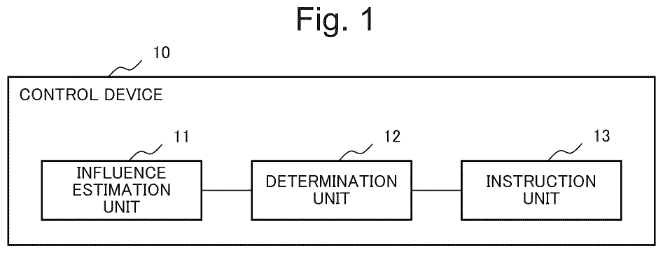

FIG. 1 illustrates a configuration example of the control device 10 of the present example embodiment. The control device 10 includes an influence estimation unit 11, a determination unit 12, and an instruction unit 13.

The control device 10 is connected to a base station. The base station performs wireless communication using sound waves with a plurality of wireless communication devices. The plurality of wireless communication devices are present underwater. In addition, the control device 10 controls a use frequency of each wireless communication device. The use frequency is a frequency to be used by the wireless communication device for wireless communication.

The influence estimation unit 11 is connected to the determination unit 12. When an interference wave that can interfere with wireless communication occurs, the influence estimation unit 11 estimates whether each of the wireless communication devices is influenced by the interference wave based on an influence range. The influence range is a range in which interference may occur in wireless communication due to the influence of the interference wave.

The determination unit 12 is connected to the influence estimation unit 11 and the instruction unit 13. Based on the influence range, the determination unit 12 identifies non-interference wireless communication devices from among wireless communication devices each using, for wireless communication, a sound wave having a frequency capable of reducing the influence of an interference wave on the interference wireless communication device. In addition, the determination unit 12 determines a non-interference wireless communication device to exchange use frequencies with the interference wireless communication device, from among the identified non-interference wireless communication devices. The interference wireless communication device is a wireless communication device influenced by an interference wave. The non-interference wireless communication devices are wireless communication devices each present at a position not influenced by an interference wave.

The instruction unit 13 is connected to the determination unit 12. The instruction unit 13 instructs the interference wireless communication device and the non-interference wireless communication device that exchange the use frequencies with each other, each to change the use frequency to the frequency after exchange.

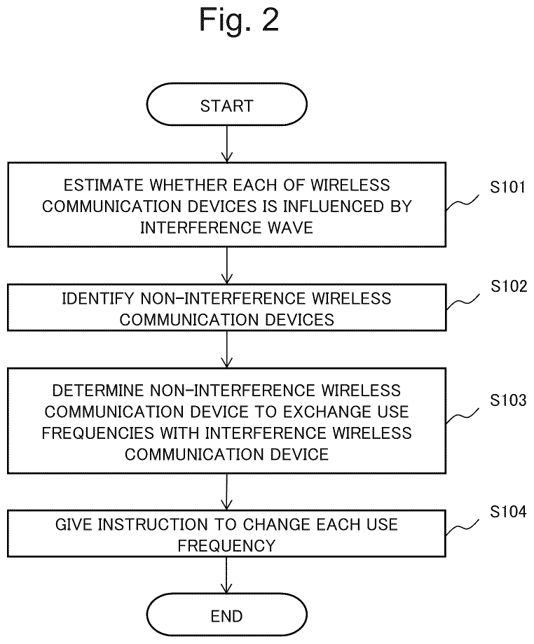

Next, FIG. 2 illustrates an example of an operation flow of the control device 10 of the present example embodiment.

When an interference wave that can interfere with wireless communication occurs, the influence estimation unit 11 estimates whether each of the wireless communication devices is influenced by the interference wave based on the influence range (step S101).

Based on the influence range, the determination unit 12 identifies non-interference wireless communication devices from among wireless communication devices each using, for wireless communication, a sound wave having a frequency capable of reducing the influence of an interference wave on the interference wireless communication device (step S102). In addition, the determination unit 12 determines a non-interference wireless communication device to exchange use frequencies with the interference wireless communication device, from among the identified non-interference wireless communication devices (step S103).

The instruction unit 13 instructs the interference wireless communication device and the non-interference wireless communication device that exchange the use frequencies with each other, each to change the use frequency to the frequency after exchange (step S104).

As described above, in the first example embodiment of the present invention, the control device 10 includes the influence estimation unit 11, the determination unit 12, and the instruction unit 13. The control device 10 is connected to a base station. The base station performs wireless communication using sound waves with a plurality of wireless communication devices. The plurality of wireless communication devices are present underwater. In addition, the control device 10 controls a use frequency of each wireless communication device. The use frequency is a frequency to be used by the wireless communication device for wireless communication. When an interference wave that can interfere with wireless communication occurs, the influence estimation unit 11 estimates whether each of the wireless communication devices is influenced by the interference wave based on an influence range. The influence range is a range in which interference may occur in wireless communication due to the influence of the interference wave. Based on the influence range, the determination unit 12 identifies non-interference wireless communication devices from among wireless communication devices each using, for wireless communication, a sound wave having a frequency capable of reducing the influence of an interference wave on the interference wireless communication device. In addition, the determination unit 12 determines a non-interference wireless communication device to exchange use frequencies with the interference wireless communication device, from among the identified non-interference wireless communication devices. The interference wireless communication device is a wireless communication device influenced by an interference wave. The non-interference wireless communication devices are wireless communication devices each present at a position not influenced by an interference wave. The instruction unit 13 instructs the interference wireless communication device and the non-interference wireless communication device that exchange the use frequencies with each other, each to change the use frequency to the frequency after exchange.

As a result, the control device 20 exchanges the use frequencies between the interference wireless communication device and the non-wireless communication device using a sound wave, for the wireless communication, having a frequency capable of reducing the influence of the interference wave on the interference wireless communication device. This can reduce the influence of the interference wave on the interference wireless communication device.

In addition, since sound waves generally propagate farther than radio waves underwater, an influence of an interference wave may occur in a plurality of wireless communication devices. Therefore, when the use frequency of the interference wireless communication device is simply exchanged with that of another wireless communication device, the another wireless communication device may be influenced by the interference wave after exchange of the use frequencies. The control device 10 of the present example embodiment identifies a non-interference wireless communication device present at a position not influenced by an interference wave based on the influence range. Then, the control device 10 exchanges the use frequencies between the interference wireless communication device and the non-interference wireless communication device. This makes it possible to prevent the wireless communication device in which the use frequency is exchanged with that of the interference wireless communication device from being influenced by the interference wave after exchange of the use frequencies.

Therefore, the control device 10 of the present example embodiment makes it possible to reduce the influence of interference in communication using underwater sound waves.

### Second Example Embodiment

Next, a second example embodiment of the present invention is described. A specific example of the control device 10 in the first example embodiment is a control device 20 in the second example embodiment.

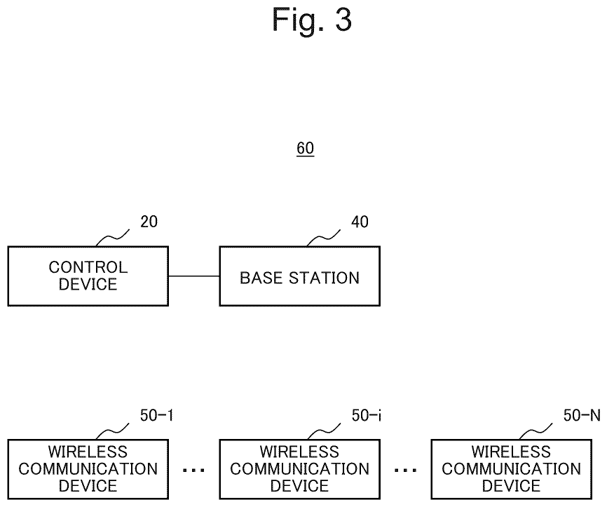

FIG. 3 illustrates a configuration example of a communication system 60 including the control device 20 of the present example embodiment. The communication system 60 includes the control device 20, a base station 40, and a wireless communication devices 50-i (i is an integer of 1 to N, and N is an integer of 2 or more).

The base station 40 is located on water. The base station 40 can perform wireless communication using sound waves with each wireless communication devices 50-i.

The wireless communication devices 50-i are present underwater. Each wireless communication device 50-i can perform wireless communication using a sound wave with the base station 40. The wireless communication device 50-i can communicate with the control device 20 via the base station 40.

The control device 20 is connected to the base station 40. The control device 20 is located on water or on land. The control device 20 can perform wireless communication using radio waves or wired communication with the base station 40. In addition, the control device 20 controls a use frequency of each wireless communication device 50-i. The use frequency is a frequency to be used by the wireless communication device 50-i for wireless communication with the base station 40 using a sound wave. Note that the wireless communication may be communication based on a band signal. In this case, the use frequency may be a frequency band. When the wireless communication is communication based on a band signal, the term “frequency” refers to a “frequency band”.

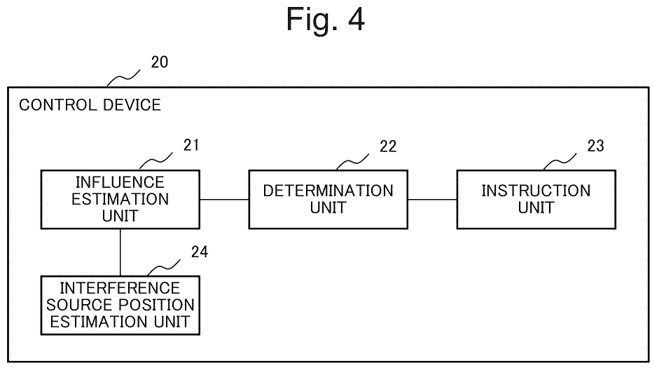

Next, FIG. 4 illustrates a configuration example of the control device 20 of the present example embodiment. The control device 20 includes an influence estimation unit 21, a determination unit 22, an instruction unit 23, and an interference source position estimation unit 24.

The influence estimation unit 21 is connected to the determination unit 22 and the interference source position estimation unit 24. When an interference wave occurs, the influence estimation unit 21 estimates whether each of the wireless communication devices 50-1 to 50-N is influenced by the interference wave based on the influence range. The interference wave is a sound wave that can interfere with wireless communication using a sound wave between the base station 40 and a wireless communication device 50-i. The influence range is a range in which interference may occur in wireless communication using a sound wave between the base station 40 and a wireless communication device 50-i due to the influence of the interference wave.

A method of detecting the occurrence of the interference wave is described below.

The influence estimation unit 21 can estimate the influence range based on, for example, position information of an interference source that emits an interference wave, a frequency of the interference wave, terrain information around the interference source, and a sound velocity around the interference source.

Among the information to be used for estimating the influence range, the position information of the interference source that emits the interference wave is estimated by the interference source position estimation unit 24. A method of estimating the position of the interference source is described below. The information on the frequency of the interference wave is acquired when the occurrence of the interference wave is detected.

The terrain information around the interference source is stored in advance in a storage unit (not illustrated) inside or outside the control device 20. Note that, in the present example embodiment, it is assumed that the base station 40 does not move or moves in a short distance if moving. The storage unit stores terrain information of underwater (for example, the seafloor) around the base station 40.

As for the sound velocity around the interference source, for example, the sound velocity in the ocean depends on water temperature, pressure (depth) and salinity concentration. The influence estimation unit 21 may receive information acquired by the information acquisition device from the information acquisition device (not illustrated) and estimate sound velocity distributions in the vertical direction and the horizontal direction based on the received information. At this time, the information acquisition device acquires depth information of the information acquisition device. The information acquisition device acquires at least one of water temperature and salinity concentration around the information acquisition device. For example, the information collection device includes a depth sensor, and acquires depth information of the information acquisition device. In addition, for example, the information acquisition device includes water temperature sensor, and acquires information on water temperature around the information acquisition device. Furthermore, for example, the information acquisition device includes salinity concentration sensor, and acquires information on salinity concentration around the information acquisition device. Note that the information acquisition device may be a wireless communication device 50-i. The information acquisition device may be an underwater drone or the like for information acquisition.

As for the position of the information acquisition device, a Global Navigation Satellite System (GNSS) cannot be used underwater. Therefore, the influence estimation unit 21 estimates the position of the information acquisition device based on the incoming direction of the sound wave emitted by the information acquisition device with respect to the base station 40. For example, the influence estimation unit 21 receives, from the base station 40, information on the incoming direction of the sound wave emitted by the information acquisition device. In addition, the influence estimation unit 21 receives information on the position (depth) of the information acquisition device in the vertical direction from the information acquisition device via the base station 40. Then, the influence estimation unit 21 can estimate the position of the information acquisition device based on the information on the incoming direction and the information on the position (depth) in the vertical direction.

Alternatively, the influence estimation unit 21 may receive information from an information server (not illustrated). The information server estimates the current water temperature and salinity concentration at a predetermined position based on, for example, past information on water temperature and salinity concentration.

Furthermore, the influence estimation unit 21 can receive information on the position (depth) in the vertical direction from each wireless communication device 50-i. The wireless communication device 50-i includes a pressure (depth) sensor and acquires information on the position (depth) of the wireless communication device 50-i in the vertical direction. The influence estimation unit 21 estimates the position of the wireless communication device 50-i in a similar manner to the above-described method.

The influence estimation unit 21 can estimate the influence range by simulating propagation of an interference wave based on sound velocity distributions in the vertical direction and the horizontal direction by, for example, the method described in NPL 1 or the like.

Note that, although the method is described in a case in which the influence estimation unit 21 estimates the influence range, the influence estimation unit 21 may receive information indicating that an interference wave has occurred and information on the influence range from another device (not illustrated). For example, the detection of the occurrence of the interference wave and the estimation of the influence range may be performed by a device different from the control device 20.

The influence estimation unit 21 determines whether the use frequency of each wireless communication device 50-i is a frequency that may be influenced by the interference wave based on the frequency of the interference wave and the use frequency of the wireless communication device 50-i. For example, when a part or all of the use frequency of the wireless communication device 50-i is included in the frequency of the interference wave or when the use frequency is in an adjacent frequency band to the frequency of the interference wave, the influence estimation unit 21 assumes that the use frequency may be influenced by the interference wave.

Furthermore, the influence estimation unit 21 determines whether the wireless communication device 50-i, which uses the frequency that may be influenced by the interference wave, is present in the influence range, based on the position information of the wireless communication device. Then, when the wireless communication device is present in the influence range, it is estimated that the wireless communication device is influenced by the interference wave.

The determination unit 22 is connected to the influence estimation unit 21 and the instruction unit 23. The determination unit 22 identifies the non-interference wireless communication devices based on the influence range. The non-interference wireless communication devices are wireless communication devices each present at a position not influenced by an interference wave. At this time, the determination unit 22 identifies non-interference wireless communication devices from among wireless communication devices each using, for wireless communication, a sound wave having a frequency capable of reducing the influence of an interference wave on the interference wireless communication device. The interference wireless communication device is a wireless communication device influenced by an interference wave.

In addition, the determination unit 22 determines a non-interference wireless communication device to exchange use frequencies with the interference wireless communication device, from among the identified non-interference wireless communication devices.

In other words, the determination unit 22 determines which wireless communication devices among the wireless communication devices 50-1 to 50-N exchange the use frequencies. Of the wireless communication devices that exchange use frequencies with each other, one is an interference wireless communication device and the other is a non-interference wireless communication device.

The determination unit 22 determines, from among the non-interference wireless communication devices, a non-interference wireless communication device that satisfies both of the following two conditions as a non-interference wireless communication device that exchanges the use frequencies with the interference wireless communication device.
The use frequency of the non-interference wireless communication device is a frequency that is not influenced by the interference wave.
The use frequency of the wireless communication device present within a predetermined distance from the non-interference wireless communication device is a frequency that does not interfere with the use frequency of the interference wireless communication device.

The instruction unit 23 is connected to the determination unit 22. The instruction unit 23 instructs the interference wireless communication device and the non-interference wireless communication device that exchange the use frequencies with each other, each to change the use frequency to the frequency after exchange. At this time, the base station 40 may not be able to communicate with the interference wireless communication device due to the influence of the interference wave. Therefore, when the wireless communication between the interference wireless communication device and the base station 40 is disabled, the instruction unit 23 may cause the base station 40 to use a predetermined spare frequency (or frequency band) and perform the instruction. In this case, the wireless communication device also uses the spare frequency when the wireless communication with the base station 40 cannot be performed.

Note that, when there is no non-interference wireless device suitable for the exchange of the use frequencies, the determination unit 22 may determine the use frequency of the wireless communication device 50-i from among candidates of the use frequencies including a usable frequency of the wireless communication device 50-i and an adjacent frequency adjacent to the usable frequency. The usable frequency is a frequency that can be used by the wireless communication device 50-i. At this time, the instruction unit 23 instructs the wireless communication device 50-i to use the determined use frequency.

A device that outputs sound waves typically output sound waves of several specific frequencies (or frequency bands) (for example, AHz, BHz, and CHz). These frequencies are the usable frequencies. In addition, the device that outputs sound waves can further output a sound wave having a frequency adjacent to a specific frequency although the output signal intensity is low.

For this reason, when there is no non-interference wireless device suitable for exchange of the use frequencies, the determination unit 22 may determine the use frequency of the wireless communication device 50-i in consideration of a frequency that is not set to the use frequency among the usable frequencies. At this time, the determination unit 22 determines the use frequencies of the wireless communication devices 50-1 to 50-N so that the wireless communication devices 50-1 to 50-N do not interfere with each other and the influences of the interference wave on the interference wireless communication devices are reduced. The determination unit 22 may further determine the use frequency of the wireless communication device 50-i in consideration of the use of the adjacent frequency. Note that the adjacent frequency has a short communicable distance since the output signal intensity is low. Therefore, the determination unit 22 can set the adjacent frequency as a candidate for the use frequency for a wireless communication device whose distance to the base station 40 is shorter than the communicable distance at the adjacent frequency.

In addition, when interference occurs with underwater sound wave communication implemented in another business, the determination unit 22 may adjust the use frequencies and the signal intensities with underwater sound wave communication implemented in the another business. For example, when the influence of the interference wave cannot be avoided even if the frequencies are exchanged between the wireless communication devices 50-1 to 50-N, the determination unit 22 may allocate the use frequencies in a state of including the underwater sound wave communication implemented in the another business (another communication system). In this case, for example, information may be transmitted and received to and from a control device of another business. In addition, the determination unit 22 may avoid interference by adjusting not only the use frequencies but also the signal intensities. Furthermore, the determination unit 22 may avoid interference by changing the output direction of the sound wave, for example, by narrowing the directivity.

Next, a method of detecting occurrence of an interference wave is described. As a method of detecting the occurrence of the interference wave, there are a method of detecting the occurrence based on a sound wave received by the base station 40 and a method of detecting the occurrence based on a sound wave received by a wireless communication device 50-i.

First, a method of detecting an interference wave based on a sound wave received by the base station 40 is described.

In this case, the base station 40 transmits information on the received sound wave to the control device 20. The information on the sound wave includes information on the incoming direction of the sound wave and information on the frequency of the sound wave. The base station 40 does not necessarily transmit sound wave information of sound waves to be used in communication with the wireless communication devices 50-1 to 50-N or sound waves each having a frequency that does not influence the use frequencies of the wireless communication devices 50-1 to 50-N.

For example, the control device 20 can determine that an interference wave has occurred when the base station 40 receives any of the following sound waves.
A sound wave incoming from a direction in which the wireless communication devices 50-1 to 50-N are not present
A sound wave incoming from a direction in which a wireless communication device among wireless communication devices 50-1 to 50-N is present, the sound wave having a frequency different from a use frequency of the wireless communication device present in the direction.
Sound wave with unknown identification information

Next, a method of detecting an interference wave based on a sound wave received by a wireless communication device 50-i is described.

In this case, the wireless communication device 50-i transmits information on the received sound wave to the control device 20 via the base station 40. The information on the sound wave includes information on the incoming direction of the sound wave and information on the frequency of the sound wave. Note that the wireless communication device 50-i does not necessarily transmit information on the sound wave to be used in communication with the base station 40 or sound waves each having a frequency that does not influence the use frequency of the wireless communication devices 50-1 to 50-N.

In addition, when being influenced by the interference wave, the wireless communication device 50-i cannot communicate at the original use frequency. Therefore, in that case, communication with the base station 40 is performed at a frequency that is not influenced by the interference wave among the spare frequencies.

Next, a method of estimating the position of the interference source is described. The position of the interference source is estimated by the interference source position estimation unit 24.

For example, the interference source position estimation unit 24 receives information on the interference wave received by the base station 40 from the base station 40. The information on the interference wave includes information on an incoming direction and a frequency of the interference wave. In addition, the interference source position estimation unit 24 receives information on the interference wave received by a wireless communication device 50-i from the wireless communication device 50-i. The position of the wireless communication device 50-i is estimated by the influence estimation unit 21. Then, the interference source position estimation unit 24 estimates the position of the interference source using the information on the interference wave estimated to be the interference wave from the same interference source among the received information on the interference waves. For example, the interference source position estimation unit 24 can determine, as the position of the interference source, an intersection of straight lines each extending in the incoming direction of the interference wave from the position of the corresponding device (the base station 40 or the wireless communication device 50-i) having received the interference wave. The interference source position estimation unit 24 may regard, for example, interference waves of the same frequency as interference waves from the same interference source.

The interference source position estimation unit 24 may further estimate the position of the interference wave based on the received signal intensity of the interference wave. In this case, the information on the interference wave further includes information on received signal intensity at the device that has received the interference wave.

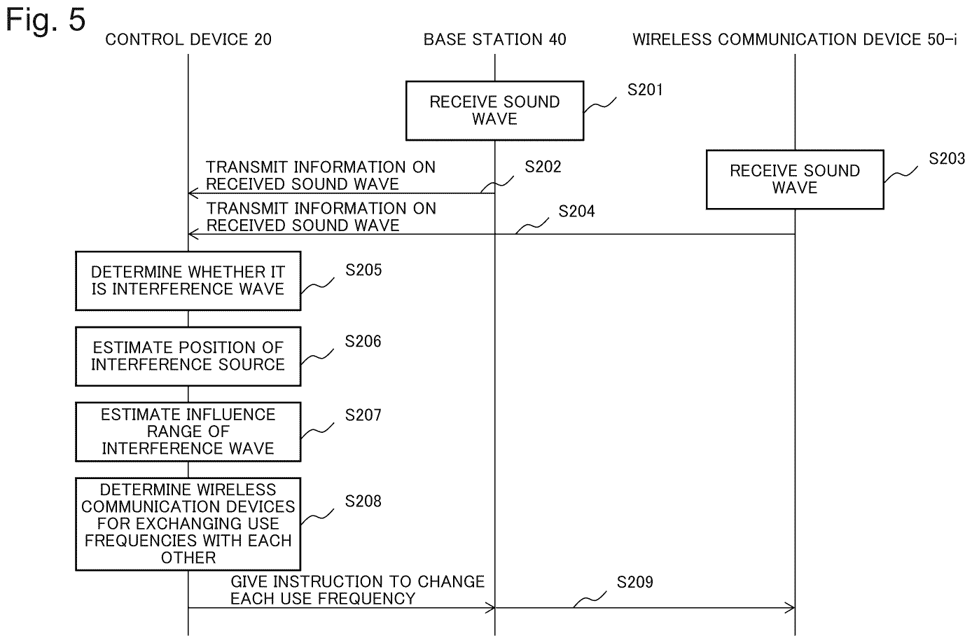

Next, an example of an operation flow of a wireless communication device 50-i, the base station 40, and the control device 20 is described with reference to FIGS. 5 and 2. FIG. 5 illustrates an operation flow of the wireless communication device 50-i, the base station 40, and the control device 20.

First, when receiving a sound wave, the base station 40 transmits information on the sound wave to the control device 20 (steps S201 and S202 in FIG. 5). When receiving a sound wave, the wireless communication device 50-i transmits information on the sound wave to the control device 20 (steps S203 and S204).

The influence estimation unit 21 of the control device 20 determines whether an interference wave has occurred based on the received information on the sound wave (step S205). When an interference wave occurs, the interference source position estimation unit 24 of the control device 20 estimates the position of the interference source (step S206). In addition, the influence estimation unit 21 of the control device 20 estimates the influence range (step S207).

Then, the control device 20 determines wireless communication devices for exchanging use frequencies with each other (step S208). The control device 20 determines the wireless communication device to exchange the use frequencies with another in the following manner.

The influence estimation unit 21 estimates whether each of the wireless communication devices 50-1 to 50-N is influenced by an interference wave based on the influence range (step S101 in FIG. 1).

The determination unit 22 identifies the non-interference wireless communication devices based on the influence range (step S102). In addition, the determination unit 22 determines a non-interference wireless communication device to exchange use frequencies with the interference wireless communication device, from among the non-interference wireless communication devices (step S103).

Then, the instruction unit 23 instructs the interference wireless communication device and the non-interference wireless communication device that exchange the use frequencies with each other, each to change the use frequency to the frequency after exchange (step S104 in FIG. 1 and step S209 in FIG. 5).

As described above, in the second example embodiment of the present invention, the control device 20 includes the influence estimation unit 21, the determination unit 22, and the instruction unit 23. The control device 20 is connected to a base station. The base station performs wireless communication using sound waves with a plurality of wireless communication devices. The plurality of wireless communication devices are present underwater. In addition, the control device 20 controls a use frequency of each wireless communication device. The use frequency is a frequency to be used by the wireless communication device for wireless communication. When an interference wave that can interfere with wireless communication occurs, the influence estimation unit 21 estimates whether each of the wireless communication devices is influenced by the interference wave based on the influence range. The influence range is a range in which interference may occur in wireless communication due to the influence of the interference wave. Based on the influence range, the determination unit 22 identifies non-interference wireless communication devices from among wireless communication devices each using, for wireless communication, a sound wave having a frequency capable of reducing the influence of an interference wave on the interference wireless communication device. In addition, the determination unit 22 determines a non-interference wireless communication device to exchange use frequencies with the interference wireless communication device, from among the identified non-interference wireless communication devices. The interference wireless communication device is a wireless communication device influenced by an interference wave. The non-interference wireless communication devices are wireless communication devices each present at a position not influenced by an interference wave. The instruction unit 23 instructs the interference wireless communication device and the non-interference wireless communication device that exchange the use frequencies with each other, each to change the use frequency to the frequency after exchange.

As a result, the control device 20 exchanges the use frequencies between the interference wireless communication device and the non-wireless communication device using a sound wave, for the wireless communication, having a frequency capable of reducing the influence of the interference wave on the interference wireless communication device. This can reduce the influence of the interference wave on the interference wireless communication device.

In addition, since sound waves generally propagate farther than radio waves underwater, an influence of an interference wave may occur in a plurality of wireless communication devices. Therefore, when the use frequency of the interference wireless communication device is simply exchanged with that of another wireless communication device, the another wireless communication device may be influenced by the interference wave after exchange of the use frequencies. The control device 20 of the present example embodiment identifies a non-interference wireless communication device present at a position not influenced by an interference wave based on the influence range. Then, the control device 20 exchanges the use frequencies between the interference wireless communication device and the non-interference wireless communication device. This makes it possible to prevent the wireless communication device in which the use frequency is exchanged with that of the interference wireless communication device from being influenced by the interference wave after exchange of the use frequencies.

Therefore, the control device 20 of the present example embodiment makes it possible to reduce the influence of interference in communication using underwater sound waves.

In addition, the control device 20 of the present example embodiment exchanges the use frequencies between the wireless communication devices 50-1 to 50-N included in the communication system 60. Therefore, the available frequency band of the communication system 60 can be efficiently used. Sound waves each have an available frequency band narrower than radio waves. Therefore, it is desirable that the available frequency band can be efficiently used.

In addition, the influence estimation unit 21 of the control device 20 of the present example embodiment estimates the influence range based on the position information of the interference source that emits the interference wave, the frequency of the interference wave, the terrain information around the interference source, and the sound velocity around the interference source. As a result, the control device 20 can estimate the influence range.

In addition, the influence estimation unit 21 receives information acquired by the information acquisition device from the information acquisition device that is present around the interference source and acquires at least one of the water temperature and the salinity concentration around the interference source, and estimates the sound velocity based on the received information. As a result, the control device 20 can estimate the influence range based on the water temperature and the salinity concentration at the time of performing the estimation.

In addition, the control device 20 includes an interference source position estimation unit 24. The interference source position estimation unit 24 estimates the position of the interference source based on the information on the interference wave received by the wireless communication device and the position information of the wireless communication device. As a result, the control device 20 can estimate the influence range based on the position of the interference source.

In addition, when the wireless communication between the interference wireless communication device and the base station 40 is disabled, the instruction unit 23 causes the base station 40 to use a predetermined spare frequency and give an instruction for changing the use frequency. As a result, the control device 20 can prevent the instruction to change the use frequency from failing to reach the interference wireless communication device due to the influence of the interference wave.

Furthermore, when there is no non-interference wireless communication device suitable for exchange of the use frequencies, the determination unit 22 determines the use frequency of each of the wireless communication devices from among candidates of the use frequencies including a usable frequency that can be used by the wireless communication device and an adjacent frequency adjacent to the usable frequency. In addition, the instruction unit 23 instructs each of the wireless communication devices to use the determined use frequency. This advantageously makes it more likely that the use frequency of each wireless communication device can be determined so as to reduce the influence of the interference wave when there is no non-interference wireless communication device suitable for exchange of the use frequencies.

### Hardware Configuration Example

A configuration example of a hardware resource is described that enables one information processing device (computer) to implement the control device (10, 20) in each example embodiment of the present invention described above. Note that the control device may be implemented physically or functionally by using at least two information processing devices. The control device may also be implemented as a dedicated device. In addition, only some functions of the control device may be implemented by using the information processing device.

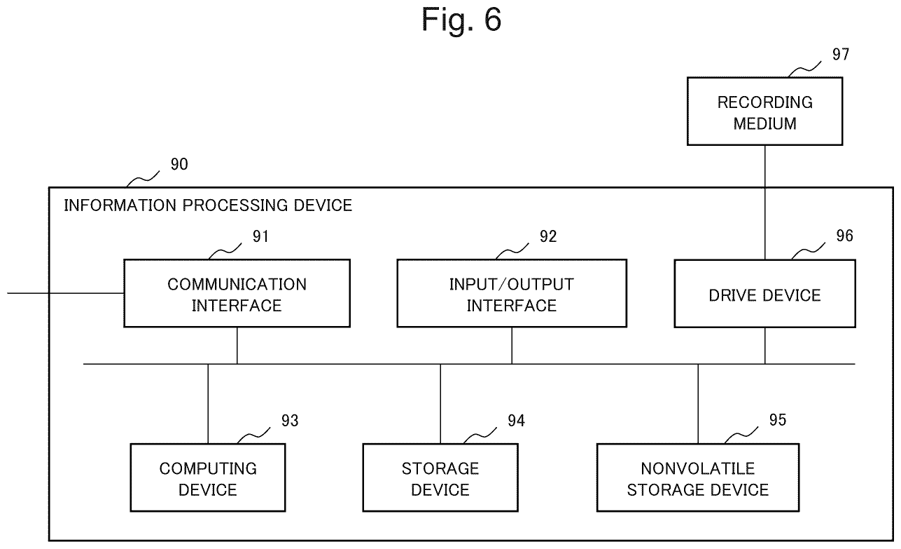

FIG. 6 is a diagram schematically illustrating a hardware configuration example of an information processing device capable of implementing the control device according to each example embodiment of the present invention. The information processing device 90 includes a communication interface 91, an input/output interface 92, a computing device 93, a storage device 94, a nonvolatile storage device 95, and a drive device 96.

For example, the influence estimation unit 11 and the instruction unit 13 in FIG. 1 can be implemented by the communication interface 91 and the computing device 93. The determination unit 12 can be implemented by the computing device 93.

The communication interface 91 is a communication means for the control device of each example embodiment to communicate with an external device in a wired or/and wireless manner. Note that, when the control device is implemented by using at least two information processing devices, the devices may be connected so as to be able to communicate with each other via the communication interface 91 between the devices.

The input/output interface 92 is a man-machine interface such as a keyboard as an example of an input device and a display as an output device.

The computing device 93 is implemented by a general-purpose central processing unit (CPU), an arithmetic processing device such as a microprocessor, or a plurality of electric circuits. For example, the computing device 93 can read various programs stored in the nonvolatile storage device 95 into the storage device 94 and execute processing according to the read program.

The storage device 94 is a memory device such as a random access memory (RAM) that can be referred to from the computing device 93, and stores programs, various data, and the like. The storage device 94 may be a volatile memory device.

The nonvolatile storage device 95 is a nonvolatile storage device such as a read only memory (ROM) or a flash memory, and can store various programs, data, and the like.

The drive device 96 is, for example, a device that processes reading and writing of data on a recording medium 97 described below.

The recording medium 97 is a recording medium capable of recording data, for example, an optical disk, a magneto-optical disk, or a semiconductor flash memory.

Each example embodiment of the present invention may be implemented, for example, by configuring a control device with the information processing device 90 illustrated in FIG. 6 and supplying the control device with a program capable of implementing the functions described in each example embodiment.

In this case, the computing device 93 can execute the program supplied to the control device to implement the example embodiment. In addition, not all but some of the functions of the control device can also be configured by the information processing device 90.

Furthermore, the program may be recorded in the recording medium 97, and the control device may be configured such that the program is appropriately stored in the nonvolatile storage device 95 at a shipment stage, an operation stage, or the like of the control device. In this case, supply method of the program may employ a method of installing the program in the control device using an appropriate jig in a manufacturing stage before shipment, an operation stage, or the like. In addition, the supply method of the program may employ a general procedure such as a method of downloading the program from the outside via a communication line such as the Internet.

Some or all of the above example embodiments may be described as the following Supplementary Notes, but are not limited to the following.

### Supplementary Note 1

A control device that is connected to a base station and controls a use frequency, the base station performing wireless communication using sound waves with a plurality of wireless communication devices present underwater, the use frequency being a frequency to be used for the wireless communication by each of the wireless communication devices, the control device comprising:
influence estimation means for estimating whether each of the wireless communication devices is influenced by an interference wave, based on an influence range, when the interference wave occurs, the interference wave being likely to interfere with the wireless communication, the influence range being a range in which interference is likely to occur in the wireless communication due to an influence of the interference wave;
determination means for identifying, based on the influence range, non-interference wireless communication devices from among the wireless communication devices each using, for the wireless communication, a sound wave having a frequency capable of reducing an influence of the interference wave on an interference wireless communication device, and for determining a non-interference wireless communication device to exchange use frequencies with the interference wireless communication device, from among the identified non-interference wireless communication devices, the interference wireless communication device being the wireless communication device influenced by the interference wave, the non-interference wireless communication devices being the wireless communication devices each present at a position not influenced by the interference wave; and
instruction means for instructing the interference wireless communication device and the non-interference wireless communication device that exchange use frequencies with each other, each to change a use frequency to a frequency after exchange.

### Supplementary Note 2

The control device according to supplementary note 1, wherein
the influence estimation means estimates the influence range based on position information of an interference source that emits the interference wave, a frequency of the interference wave, terrain information around the interference source, and a sound velocity around the interference source.

### Supplementary Note 3

The control device according to supplementary note 2, wherein
the influence estimation means receives information acquired by an information acquisition device from the information acquisition device, and estimates the sound velocity based on received information, the information acquisition device being present around the interference source, the information acquisition device acquiring at least one of water temperature and salinity concentration around the interference source.

### Supplementary Note 4

The control device according to supplementary note 2 or 3, further comprising
interference source position estimation means for estimating a position of the interference source based on information on the interference wave received by the wireless communication devices and position information of the wireless communication devices.

### Supplementary Note 5

The control device according to any of supplementary notes 1 to 4, wherein
when the wireless communication between the interference wireless communication device and the base station is disabled, the instruction means causes the base station to use a predetermined spare frequency and instructs the base station to change a use frequency.

### Supplementary Note 6

The control device according to any of supplementary notes 1 to 5, wherein
when there is not the non-interference wireless communication device suitable for the exchange of use frequencies, the determination means determines a use frequency of each of the wireless communication devices from among candidates of use frequencies including a usable frequency that can be used by the wireless communication device and an adjacent frequency adjacent to the usable frequency, and
the instruction means instructs each of the wireless communication devices to use a determined use frequency.

### Supplementary Note 7

A control system that is connected to a base station and controls a use frequency, the base station performing wireless communication using sound waves with a plurality of wireless communication devices present underwater, the use frequency being a frequency to be used for the wireless communication by each of the wireless communication devices, the control system comprising:
influence estimation means for estimating whether each of the wireless communication devices is influenced by an interference wave, based on an influence range, when the interference wave occurs, the interference wave being likely to interfere with the wireless communication, the influence range being a range in which interference is likely to occur in the wireless communication due to an influence of the interference wave;
determination means for identifying, based on the influence range, non-interference wireless communication devices from among the wireless communication devices each using, for the wireless communication, a sound wave having a frequency capable of reducing an influence of the interference wave on an interference wireless communication device, and for determining a non-interference wireless communication device to exchange use frequencies with the interference wireless communication device, from among the identified non-interference wireless communication devices, the interference wireless communication device being the wireless communication device influenced by the interference wave, the non-interference wireless communication devices being the wireless communication devices each present at a position not influenced by the interference wave; and
instruction means for instructing the interference wireless communication device and the non-interference wireless communication device that exchange use frequencies with each other, each to change a use frequency to a frequency after exchange.

### Supplementary Note 8

A control method of a control device that is connected to a base station and controls a use frequency, the base station performing wireless communication using sound waves with a plurality of wireless communication devices present underwater, the use frequency being a frequency to be used for the wireless communication by each of the wireless communication devices, the method comprising:
estimating whether each of the wireless communication devices is influenced by an interference wave, based on an influence range, when the interference wave occurs, the interference wave being likely to interfere with the wireless communication, the influence range being a range in which interference is likely to occur in the wireless communication due to an influence of the interference wave;
identifying, based on the influence range, non-interference wireless communication devices from among the wireless communication devices each using, for the wireless communication, a sound wave having a frequency capable of reducing an influence of the interference wave on an interference wireless communication device, and determining a non-interference wireless communication device to exchange use frequencies with the interference wireless communication device, from among the identified non-interference wireless communication devices, the interference wireless communication device being the wireless communication device influenced by the interference wave, the non-interference wireless communication devices being the wireless communication devices each present at a position not influenced by the interference wave; and
instructing the interference wireless communication device and the non-interference wireless communication device that exchange use frequencies with each other, each to change a use frequency to a frequency after exchange.

### Supplementary Note 9

The control method according to supplementary note 8, further comprising
estimating the influence range based on position information of an interference source that emits the interference wave, a frequency of the interference wave, terrain information around the interference source, and a sound velocity around the interference source.

### Supplementary Note 10

A computer-readable recording medium that has recorded a control program of a control device that is connected to a base station and controls a use frequency, the base station performing wireless communication using sound waves with a plurality of wireless communication devices present underwater, the use frequency being a frequency to be used for the wireless communication by each of the wireless communication devices, the medium comprising
causing a computer to implement:
an influence estimation function for estimating whether each of the wireless communication devices is influenced by an interference wave, based on an influence range, when the interference wave occurs, the interference wave being likely to interfere with the wireless communication, the influence range being a range in which interference is likely to occur in the wireless communication due to an influence of the interference wave;
a determination function for identifying, based on the influence range, non-interference wireless communication devices from among the wireless communication devices each using, for the wireless communication, a sound wave having a frequency capable of reducing an influence of the interference wave on an interference wireless communication device, and for determining a non-interference wireless communication device to exchange use frequencies with the interference wireless communication device, from among the identified non-interference wireless communication devices, the interference wireless communication device being the wireless communication device influenced by the interference wave, the non-interference wireless communication devices being the wireless communication devices each present at a position not influenced by the interference wave; and
an instruction function for instructing the interference wireless communication device and the non-interference wireless communication device that exchange use frequencies with each other, each to change a use frequency to a frequency after exchange.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese Patent Application No. 2023-029647, filed on Feb. 28, 2023, the disclosure of which is incorporated herein in its entirety by reference.

### REFERENCE SIGNS LIST

10, 20 control device
11, 21 influence estimation unit
12, 22 determination unit
13, 23 instruction unit
24 interference source position estimation unit
40 base station
50-i wireless communication device
90 information processing device
91 communication interface
92 input/output interface
93 computing device
94 storage device
95 nonvolatile storage device
96 drive device
97 recording medium

What is claimed is:

1. A control device that is connected to a base station and controls a use frequency, the base station performing wireless communication using sound waves with a plurality of wireless communication devices present underwater, the use frequency being a frequency to be used for the wireless communication by each of the wireless communication devices, the control device comprising one or more memories storing instructions and one or more processors configured to execute the instructions to:
estimate whether each of the wireless communication devices is influenced by an interference wave, based on an influence range, when the interference wave occurs, the interference wave being likely to interfere with the wireless communication, the influence range being a range in which interference is likely to occur in the wireless communication due to an influence of the interference wave;
identify, based on the influence range, non-interference wireless communication devices from among the wireless communication devices each using, for the wireless communication, a sound wave having a frequency capable of reducing an influence of the interference wave on an interference wireless communication device, and determine a non-interference wireless communication device to exchange use frequencies with the interference wireless communication device, from among the identified non-interference wireless communication devices, the interference wireless communication device being the wireless communication device influenced by the interference wave, the non-interference wireless communication devices being the wireless communication devices each present at a position not influenced by the interference wave; and
instruct the interference wireless communication device and the non-interference wireless communication device that exchange use frequencies with each other, each to change a use frequency to a frequency after exchange.

2. The control device according to claim 1, wherein
the processors are configured to execute the instructions to estimate the influence range based on position information of an interference source that emits the interference wave, a frequency of the interference wave, terrain information around the interference source, and a sound velocity around the interference source.

3. The control device according to claim 2, wherein
the processors are configured to execute the instructions to receive information acquired by an information acquisition device from the information acquisition device, and estimate the sound velocity based on received information, the information acquisition device being present around the interference source, the information acquisition device acquiring at least one of water temperature and salinity concentration around the interference source.

4. The control device according to claim 2, wherein
the processors are configured to execute the instructions to estimate a position of the interference source based on information on the interference wave received by the wireless communication devices and position information of the wireless communication devices.

5. The control device according to claim 1, wherein
when the wireless communication between the interference wireless communication device and the base station is disabled, the processors are configured to execute the instructions to cause the base station to use a predetermined spare frequency.

6. The control device according to claim 1, wherein
the processors are configured to execute the instructions to determine, when there is not the non-interference wireless communication device suitable for the exchange of use frequencies, use frequency of each of the wireless communication devices from among candidates of use frequencies including a usable frequency that can be used by the wireless communication device and an adjacent frequency adjacent to the usable frequency, and
instruct each of the wireless communication devices to use a determined use frequency.

7. (canceled)

8. A control method of a control device that is connected to a base station and controls a use frequency, the base station performing wireless communication using sound waves with a plurality of wireless communication devices present underwater, the use frequency being a frequency to be used for the wireless communication by each of the wireless communication devices, the method comprising:
estimating whether each of the wireless communication devices is influenced by an interference wave, based on an influence range, when the interference wave occurs, the interference wave being likely to interfere with the wireless communication, the influence range being a range in which interference is likely to occur in the wireless communication due to an influence of the interference wave;
identifying, based on the influence range, non-interference wireless communication devices from among the wireless communication devices each using, for the wireless communication, a sound wave having a frequency capable of reducing an influence of the interference wave on an interference wireless communication device, and determining a non-interference wireless communication device to exchange use frequencies with the interference wireless communication device, from among the identified non-interference wireless communication devices, the interference wireless communication device being the wireless communication device influenced by the interference wave, the non-interference wireless communication devices being the wireless communication devices each present at a position not influenced by the interference wave; and
instructing the interference wireless communication device and the non-interference wireless communication device that exchange use frequencies with each other, each to change a use frequency to a frequency after exchange.

9. The control method according to claim 8, further comprising
estimating the influence range based on position information of an interference source that emits the interference wave, a frequency of the interference wave, terrain information around the interference source, and a sound velocity around the interference source.

10. A non-transitory computer-readable recording medium that has recorded a control program of a control device that is connected to a base station and controls a use frequency, the base station performing wireless communication using sound waves with a plurality of wireless communication devices present underwater, the use frequency being a frequency to be used for the wireless communication by each of the wireless communication devices, the medium comprising
causing a computer to implement:
an influence estimation function for estimating whether each of the wireless communication devices is influenced by an interference wave, based on an influence range, when the interference wave occurs, the interference wave being likely to interfere with the wireless communication, the influence range being a range in which interference is likely to occur in the wireless communication due to an influence of the interference wave;
a determination function for identifying, based on the influence range, non-interference wireless communication devices from among the wireless communication devices each using, for the wireless communication, a sound wave having a frequency capable of reducing an influence of the interference wave on an interference wireless communication device, and for determining a non-interference wireless communication device to exchange use frequencies with the interference wireless communication device, from among the identified non-interference wireless communication devices, the interference wireless communication device being the wireless communication device influenced by the interference wave, the non-interference wireless communication devices being the wireless communication devices each present at a position not influenced by the interference wave; and
an instruction function for instructing the interference wireless communication device and the non-interference wireless communication device that exchange use frequencies with each other, each to change a use frequency to a frequency after exchange.

11. The control device according to claim 3, wherein
the processors are configured to execute the instructions to estimate a position of the interference source based on information on the interference wave received by the wireless communication devices and position information of the wireless communication devices.

12. The control device according to claim 2, wherein
when the wireless communication between the interference wireless communication device and the base station is disabled, the processors are configured to execute the instructions to cause the base station to use a predetermined spare frequency.

13. The control device according to claim 3, wherein
when the wireless communication between the interference wireless communication device and the base station is disabled, the processors are configured to execute the instructions to cause the base station to use a predetermined spare frequency.

14. The control device according to claim 4, wherein
when the wireless communication between the interference wireless communication device and the base station is disabled, the processors are configured to execute the instructions to cause the base station to use a predetermined spare frequency.

15. The control device according to claim 2, wherein
the processors are configured to execute the instructions to
determine, when there is not the non-interference wireless communication device suitable for the exchange of use frequencies, a use frequency of each of the wireless communication devices from among candidates of use frequencies including a usable frequency that can be used by the wireless communication device and an adjacent frequency adjacent to the usable frequency, and
instruct each of the wireless communication devices to use a determined use frequency.

16. The control device according to claim 3, wherein
the processors are configured to execute the instructions to
determine, when there is not the non-interference wireless communication device suitable for the exchange of use frequencies, a use frequency of each of the wireless communication devices from among candidates of use frequencies including a usable frequency that can be used by the wireless communication device and an adjacent frequency adjacent to the usable frequency, and
instruct each of the wireless communication devices to use a determined use frequency.

17. The control device according to claim 4, wherein
the processors are configured to execute the instructions to
determine, when there is not the non-interference wireless communication device suitable for the exchange of use frequencies, a use frequency of each of the wireless communication devices from among candidates of use frequencies including a usable frequency that can be used by the wireless communication device and an adjacent frequency adjacent to the usable frequency, and
instruct each of the wireless communication devices to use a determined use frequency.

18. The control device according to claim 5, wherein
the processors are configured to execute the instructions to
determine, when there is not the non-interference wireless communication device suitable for the exchange of use frequencies, a use frequency of each of the wireless communication devices from among candidates of use frequencies including a usable frequency that can be used by the wireless communication device and an adjacent frequency adjacent to the usable frequency, and
instruct each of the wireless communication devices to use a determined use frequency.
